(19) United States
(12) Patent Application Publication
(10) Pub. No.: US 2015/0359378 A1
(43) Pub. Date: Dec. 17, 2015

(54) AUTOMATIC COFFEE MAKER AND METHOD OF PREPARING A BREWED BEVERAGE

(71) Applicant: EURO-PRO OPERATING LLC, Newton, MA (US)

(72) Inventors: Joshua Anthony, Newton, MA (US); Justin Riley, Newton, MA (US); Darwin Keith Lucas, Arlington, MA (US)

(21) Appl. No.: 14/812,731

(22) Filed: Jul. 29, 2015

Related U.S. Application Data
(63) Continuation-in-part of application No. 14/568,471, filed on Dec. 12, 2014.
Application No. 14/568,471 is a continuation-in-part of application No. 14/307,289, filed on Jun. 17, 2014.

(51) Int. Cl. A47J 31/41; A47J 31/24; A47J 31/10

(52) U.S. Cl. CPC A47J 31/41; A47J 31/103; A47J 31/24

(57) ABSTRACT

A beverage system is provided including a housing having a water outlet. A water reservoir is mounted to the housing. The water reservoir is arranged in fluid communication with the water outlet via at least one fluid conduit. A flow meter is disposed within the at least one fluid conduit. The flow meter is configured to measure a volume of water supplied to the water outlet. A heating mechanism is configured to heat at least a portion of the water within the at least one fluid conduit. Water is selectively supplied to the water outlet without a pump.

### CROSS-REFERENCE TO RELATED APPLICATION

This application claims the benefit of U.S. patent application Ser. No. 14/307,289 filed Jun. 17, 2014, and U.S. patent application Ser. No. 14/568,471 filed Dec. 12, 2014, the entire contents of which are incorporated herein by reference.

### BACKGROUND

Exemplary embodiments of the present disclosure relate to a system and method for brewing beverages, and more particularly to a system and method of automatically brewing a beverage having a desired flavor profile.

Various systems and methods for brewing a beverage, such as coffee, are known. Known systems include drip brewing systems in which hot water is filtered through coffee grounds and into a carafe and French press systems in which coffee grounds and hot water are mixed in a container and a water permeable plunger is pressed into the container from above to trap the ground coffee at the bottom of the container.

Accordingly, a beverage brewing system capable of automatically brewing a beverage having a desired flavor profile, regardless of the type or volume of beverage selected, is desirable.

### SUMMARY

According to one embodiment, a beverage system is provided including a housing having a water outlet. A water reservoir is mounted to the housing. The water reservoir is arranged in fluid communication with the water outlet via at least one fluid conduit. A flow meter is disposed within the at least one fluid conduit. The flow meter is configured to measure a volume of water supplied to the water outlet. A heating mechanism is configured to heat at least a portion of the water within the at least one fluid conduit. Water is selectively supplied to the water outlet without a pump.

In addition to one or more of the features described above, or as an alternative, in further embodiments water is selectively supplied to said water outlet by operating said heating mechanism.

In addition to one or more of the features described above, or as an alternative, in further embodiments pressure generated by operating said heating mechanism is configured to supply a volume of water to said water outlet.

In addition to one or more of the features described above, or as an alternative, in further embodiments said heating mechanism and said flow meter are operably coupled to a controller.

In addition to one or more of the features described above, or as an alternative, in further embodiments said controller is configured to control operation of said heating mechanism based on said volume of water measured by said flow meter.

In addition to one or more of the features described above, or as an alternative, in further embodiments water from said water reservoir is fed to said flow meter by gravity.

In addition to one or more of the features described above, or as an alternative, in further embodiments said flow meter is a paddle wheel.

In addition to one or more of the features described above, or as an alternative, in further embodiments said heating mechanism is operable only when the water reservoir contains a fluid.

According to another embodiment, a beverage system is provided including a housing configured to receive a container for storing a beverage prepared by the beverage system. A heating mechanism is positioned within the housing. The heating mechanism is configured to selectively heat the beverage within the container. A thermal regulation device is operably coupled to the heating mechanism. The thermal regulation device is configured to monitor a temperature of at least one of the beverage and container such that the temperature remains within a predetermined threshold to maintain a flavor profile of the beverage.

In addition to one or more of the features described above, or as an alternative, in further embodiments said heat provided by said heating mechanism affects said flavor profile of said beverage when said heat breaks down one or more compounds within said beverage.

In addition to one or more of the features described above, or as an alternative, in further embodiments said thermal regulation device is a thermistor.

In addition to one or more of the features described above, or as an alternative, in further embodiments said thermal regulation device is a thermostat.

In addition to one or more of the features described above, or as an alternative, in further embodiments said housing includes a floor configured to receive said container and said heating mechanism is positioned within said floor.

According to another embodiment, a beverage system is provided including a housing configured to receive a container. A shower head is mounted to the housing. The shower head is substantially vertically aligned with the container. A water reservoir is removably coupled to a portion of the housing. A brew basket is removably mounted to the housing directly beneath the shower head. The brew basket includes a generally hollow body configured to define a brew chamber therein. At least one outlet opening formed in the body of the brew basket is fluidly coupled to the brew chamber.

In addition to one or more of the features described above, or as an alternative, in further embodiments said generally hollow body includes at least one overflow orifice configured to stow a volume of fluid to prevent overflow.

In addition to one or more of the features described above, or as an alternative, in further embodiments said at least one overflow orifice is positioned adjacent a sidewall of said hollow body.

In addition to one or more of the features described above, or as an alternative, in further embodiments said at least one outlet opening includes two substantially identical outlet openings.

In addition to one or more of the features described above, or as an alternative, in further embodiments said at least one outlet opening includes a single outlet opening.

In addition to one or more of the features described above, or as an alternative, in further embodiments the single outlet opening includes a siphon having a pipe fluidly coupled to the brew chamber and extending from a sidewall of said hollow body.

In addition to one or more of the features described above, or as an alternative, in further embodiments a flow control device is mounted to said hollow body adjacent said at least one opening. The flow control device is configured to selectively control a flow of the fluid through the at least one opening.

In addition to one or more of the features described above, or as an alternative, in further embodiments said flow control device is movable between a first position where fluid is configured to flow freely through said at least one opening, and a second position where no fluid is configured to flow through said at least one opening.

In addition to one or more of the features described above, or as an alternative, in further embodiments said hollow body is configured to slidably mount to one or more rails of said housing.

In addition to one or more of the features described above, or as an alternative, in further embodiments said water reservoir and said portion of said housing to which said water reservoir is coupled are substantially identical in diameter.

In addition to one or more of the features described above, or as an alternative, in further embodiments said brew basket and said shower head are laterally offset from said water reservoir.

In addition to one or more of the features described above, or as an alternative, in further embodiments a platform is mounted to said housing. The platform is movable between a retracted position and an extended position. In the extended position said floor, said platform, said brew basket, and said shower head are substantially aligned about a vertical axis.

According to another embodiment, a beverage system is provided including a housing having a flow meter. A water reservoir configurable with the housing including a chamber for receiving a liquid. The water reservoir is arranged in fluid communication with the flow meter. The water reservoir is disposed vertically above the flow meter such that a flow of liquid from the chamber to the flow meter is driven by gravity.

In addition to one or more of the features described above, or as an alternative, in further embodiments said liquid is configured to flow from said chamber until reaching equilibrium.

In addition to one or more of the features described above, or as an alternative, in further embodiments said flow meter is arranged within a fluid conduit, upstream from a heating mechanism.

In addition to one or more of the features described above, or as an alternative, in further embodiments said flow meter is a paddle wheel.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1 is a graph representing Strength (% TDS) vs. Extraction (%) of Brewed Coffee;

FIG. 2 is a schematic diagram of a beverage brewing apparatus according to an embodiment;

FIG. 3 is a perspective view of a beverage brewing apparatus according to an embodiment;

FIG. 4 is a perspective view of another beverage brewing apparatus according to an embodiment;

FIG. 5 is a perspective view of yet another beverage brewing apparatus according to an embodiment;

FIG. 6 is a schematic diagram of a cross-section of a beverage brewing apparatus according to an embodiment;

FIG. 7 is another perspective view of a beverage brewing apparatus according to an embodiment;

FIG. 8 is a perspective view of a water reservoir of a beverage brewing apparatus according to an embodiment;

FIG. 8a is a front view of another water reservoir of a beverage brewing apparatus according to an embodiment;

FIG. 9 is a perspective view of a lid of the water reservoir of a FIG. 8 according to an embodiment;

FIG. 10 is a cross-sectional view of a brew basket of the beverage brewing apparatus according to an embodiment;

FIG. 11a is a bottom view of a brew basket of the beverage brewing apparatus when a drip stop assembly is in a first position according to an embodiment;

FIG. 11b is a bottom view of a brew basket of the beverage brewing apparatus when a drip stop assembly is in a second position according to an embodiment;

FIG. 12a is a cross-sectional view of a shower head of the beverage brewing apparatus according to an embodiment;

FIG. 12b is a bottom view of a shower head of the beverage brewing apparatus according to an embodiment of the invention;

FIG. 13 a graph representing Strength (% TDS) vs. Extraction (%) of Brewed Coffee including the flavor profiles achieved by the beverage brewing apparatus according to an embodiment;

FIG. 14 is a flow chart of a method of preparing a brewed beverage using the beverage brewing apparatus according to an embodiment;

FIG. 15 is a graph representing Volume of Water Delivered vs. Time (Cool Temperature Water);

FIG. 16 is a graph representing Time to First Delivery vs. Time Elapsed Since Previous Operation of the Heating Mechanism;

FIG. 17 is a top perspective view of a portion of a brew basket according to another embodiment;

FIG. 18 is a cross-sectional view of the portion of the brew basket of FIG. 17 according to another embodiment; and

FIG. 19 is a perspective view of the housing of the beverage brewing apparatus according to another embodiment.

The detailed description explains embodiments of the disclosure, together with advantages and features, by way of example with reference to the drawings.

### DETAILED DESCRIPTION

Aspects and embodiments disclosed herein include a system and method for preparing various brewed beverages. Although the disclosure is described herein with reference to preparing a brewed coffee beverage, preparation of other brewed beverages is within the scope of the disclosure. As the term is used herein, “coffee” refers to a beverage including solids extracted from coffee beans and dissolved in water. Brewed coffee is typically prepared by passing hot water through dried and ground coffee beans, referred to herein as “ground coffee.” Solids from the ground coffee are dissolved in the hot water as it passes there through.

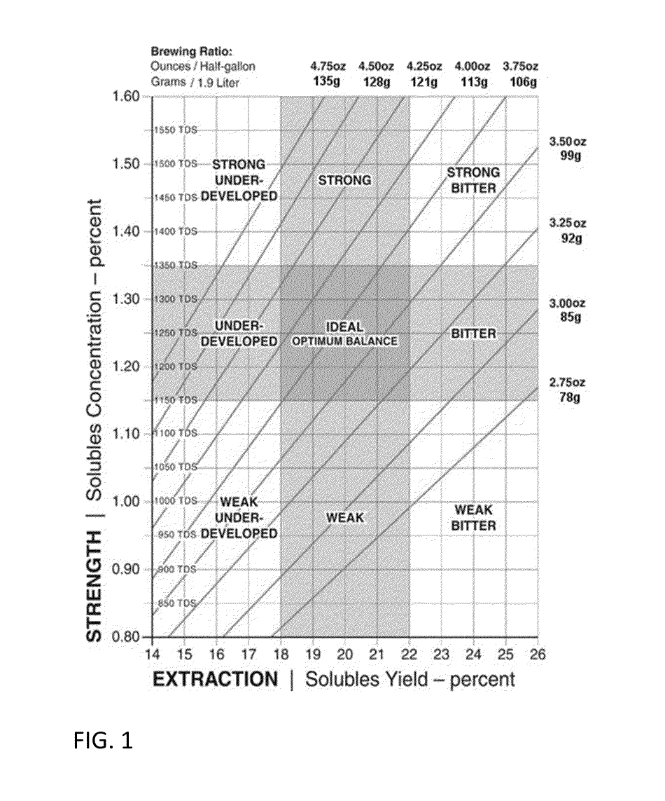

The flavor profile of brewed coffee is a balance between strength (solubles concentration) and extraction (solubles yield), as shown in FIG. 1. Strength refers to the measured amount of solids extracted into the coffee. Strength is typically expressed as a percentage of total dissolved solids (% TDS). For example, for 100 g of coffee measuring 1.2% TDS, 98.8 g of the coffee is water and 1.2 g is dissolved coffee solids. Extraction, or solubles yield, refers to the percentage of the ground coffee by weight that is removed by dissolving water during the brewing process. Up to 30% of the available soluble solids in ground coffee can be extracted, with most of the remaining 70% being insoluble in water. The solubles yield of brewed coffee is dependent on multiple factors, including, but not limited to, the temperature of the water passed through the ground coffee, the grind size of the ground coffee, and the amount of time that the water is in contact with the ground coffee. For example, ground coffee with a larger grind size may require a higher water temperature or a longer water contact time at a lower temperature to achieve an equivalent amount of soluble extraction as a ground coffee having a smaller grind size.

Over the years, various institutions and committees within the coffee industry have established a “gold cup” standard that coffee having an extraction between about 18% and 22% and a percentage of total dissolved solids between about 1.15 and 1.35 percent will generally yield the best quality of brewed coffee. As shown in the FIG., coffee with an extraction of greater than 22% will have a sharp increase in the soluble components that contribute to the bitter taste associated with over-extraction, and coffee with an extraction of less than 18% is generally associated with sour, under-developed taste.

The amount of water used to brew the coffee should also be controlled to produce a coffee having a pleasant flavor and strength. The strength of the coffee will vary depending on multiple factors including, the ratio of ground coffee to water being used, grind size, and contact time between the coffee grounds and the water for example. In a general application, the use of too much water may result in coffee that is weak, and the use of too little water may result in coffee which is undesirably strong.

The temperature of the water used is also considered an important variable in determining a proper balance and taste. This is because cooler water may not extract a desirable quantity of solubles that make up the flavor of brewed coffee. Similarly, hotter water may extract a higher ratio of bitter solubles than desired. As a result, it is generally desirable to use water for brewing coffee such that temperature in the brewing chamber is between about 195° F. and 205° F. (91° C.-96° C.).

It is known that pre-soaking or wetting the ground coffee with water, such as prior to delivering the majority of the hot water used to brew the coffee, may result in a brewed coffee having a more pleasant taste than brewed coffee produced without pre-soaking the ground coffee. Pre-soaking the ground coffee releases gasses trapped within the coffee grounds, such as carbon dioxide for example. As a result, the portion of the ground coffee configured to evenly absorb and filter the water is increased. The water used for pre-soaking the ground coffee may be referred to herein as “bloom water” and the amount of time that the boom water is exposed to the ground coffee to pre-soak the ground coffee is referred to as “bloom time.” The water used to brew the coffee from the ground coffee after the bloom water, will be referred to herein as “brew water.” The brew water is delivered to the ground coffee after completion of pre-soaking of the ground coffee with the bloom water for a bloom time. The ratio of the volume of bloom water to the mass of ground coffee, in addition to other factors, also contributes to the production of a balanced, pleasant tasting coffee.

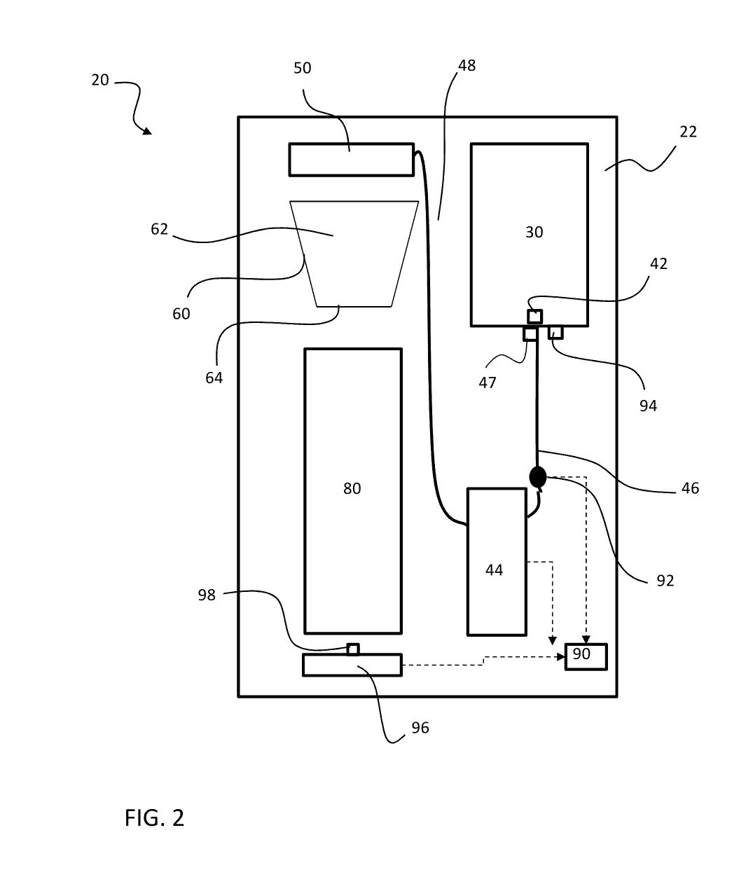

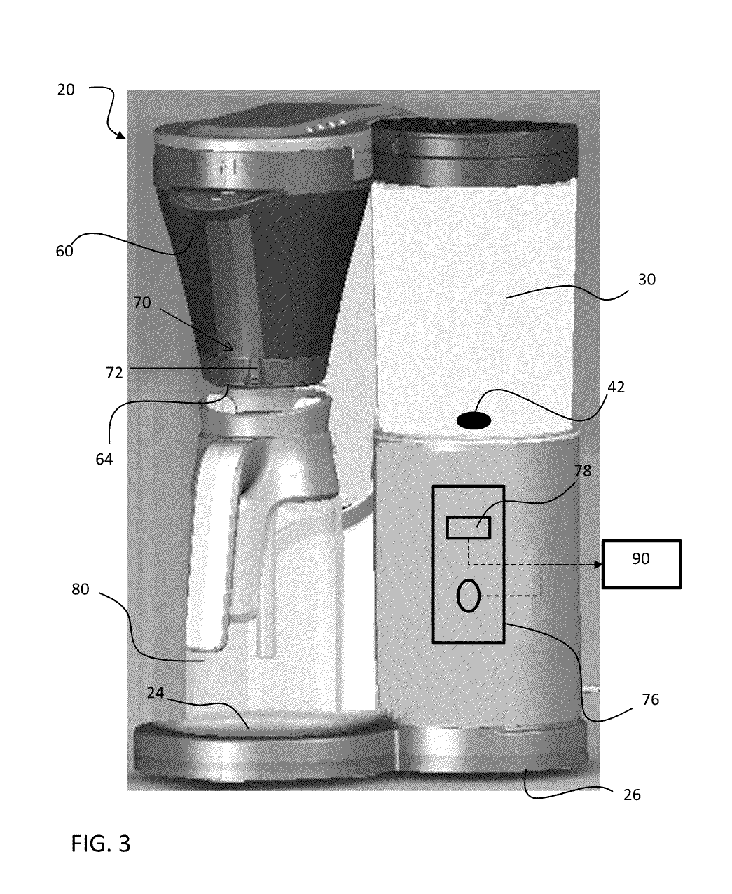

Referring now to FIGS. 2-12 and 17-19, an automated beverage brewing apparatus 20 according to an embodiment of the disclosure is illustrated in more detail. The apparatus 20 is capable of producing a pleasantly flavored beverage, such as coffee for example, by controlling not only the quantity of water used to brew the coffee, but also the time for which the water is in contact with the ground coffee. The apparatus includes a housing 22, a water reservoir 30, a heating mechanism 44, a shower head 50, and a brew basket 60. The water reservoir 30 is a generally hollow container affixed to a portion of the housing 22. The reservoir 30 is configured to store a desired amount of water therein for brewing a beverage, such as coffee for example, and in some embodiments may be detachable from the housing 22 for ease of use.

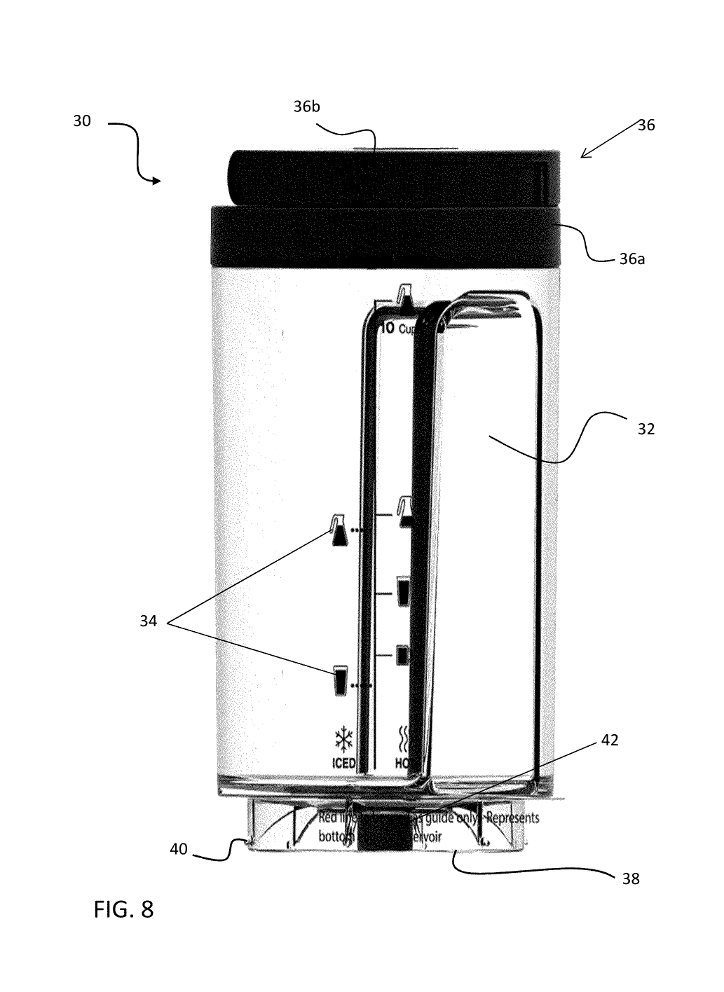

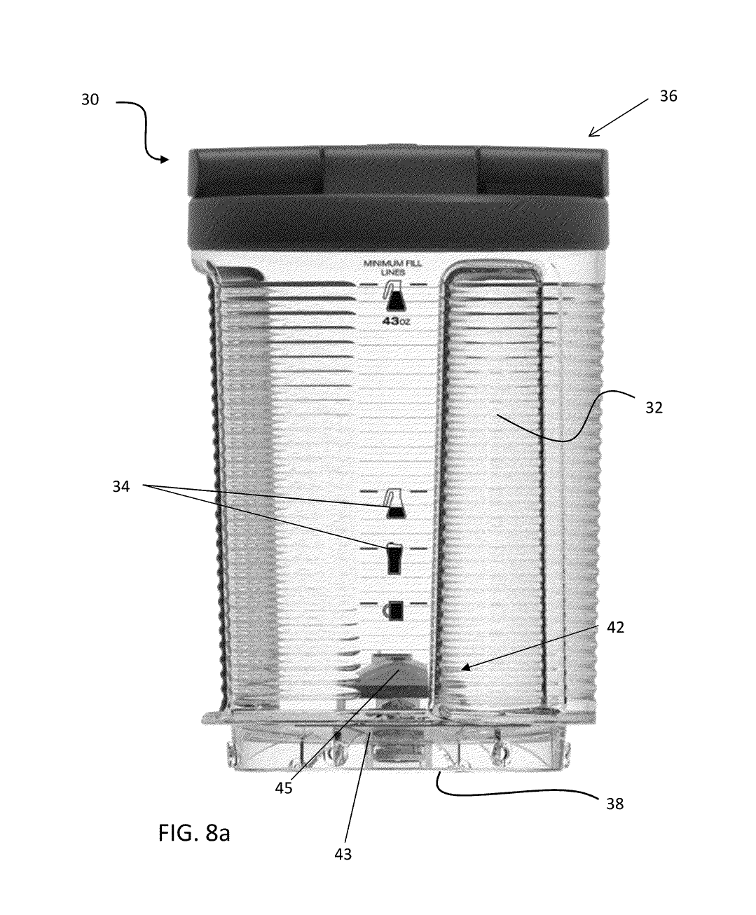

An example of the water reservoir 30 is illustrated in more detail in FIGS. 8, 8a and 9. In the illustrated, non-limiting embodiment, the reservoir 30 includes one or more contours 32, such as recessed grips for example, to allow a user to transport the water reservoir 30 with one hand. One or more markings 34 may be formed on the reservoir 30 to indicate to a user a sufficient amount of water appropriate for one or more of the selectable brewing sizes. As shown in the embodiment of FIG. 8a, the water reservoir 30 may be formed including one or more ribs extending horizontally about a periphery of the reservoir 30.

A lid 36 for the reservoir may be integrally formed into the housing 22, or alternatively, may be a separate component, removably attached to the reservoir 30. As shown in FIG. 8, the lid 36 may include a first portion 36a configured to attach, such as by threaded engagement for example, to a portion of the reservoir 30, and a second portion 36b coupled to the first portion 36a and movable between a closed position (FIG. 8) and an open position (FIG. 9) to easily fill the reservoir 30 with water. In one embodiment, the first portion 36a of the lid 36 is movable about 180 degrees between the closed position and the open position.

In one embodiment, an outlet end 38 of the reservoir 30 includes at least one connector 40 configured to slidably engage a plurality of complementary connectors (not shown) arranged within a portion of the housing 22 to lock the reservoir in place. A plug 42, best seen in FIG. 8a, is generally arranged within the opening (not shown) formed at the outlet end 38 of the reservoir 30. The plug 42 generally includes a shaft 43 positioned at least partially within the opening and a base 45 having a diameter larger than the adjacent opening. When the reservoir 30 is detached from the housing 22, the base 45 is arranged in contact with the end 38 of the reservoir 30 to block a flow of water from the outlet end 38 thereof. However, when the reservoir 30 is connected to the housing 22, the plug 42 is configured to move vertically, thereby creating a gap between the base 45 and the outlet end 38 to allow a flow of water through the outlet end 38. In one embodiment, the plug 42 is spring loaded and is biased to the position to block a flow from the reservoir 30. A particulate filter may also be formed within the plug 42 or directly within the opening of the outlet end 38.

The heating mechanism 44, arranged within an interior of the housing 22, is fluidly coupled to the outlet end 38 of the water reservoir 30 via a first conduit 46 and is arranged in fluid communication with the shower head 50 via a second conduit 48. Another plug 47 may be disposed within either the housing 22 or the first conduit 46, adjacent the outlet end 38 of the water reservoir 30. Similar to plug 42, plug 47 may include a biasing mechanism, such as a spring for example, configured to bias the plug 47 into a position to block a flow of water through the end of the first conduit 46 when the water reservoir 30 is not connected to the housing 22. When connected to the housing 22, the water reservoir 30 applies a force to plug 47, opposite the biasing mechanism, such that the plug 47 is moved to a second position and the water reservoir 30 and first conduit 46 are arranged in fluid communication. The first conduit 46 and the second conduit 48 may be formed from the same or different food safe materials, such as food grade silicone tubing, stainless steel tubing, or polymeric tubing for example. In one embodiment, the heating mechanism 44 is a boiler and is configured to heat the water from the reservoir 30 before supplying it to the showerhead 50.

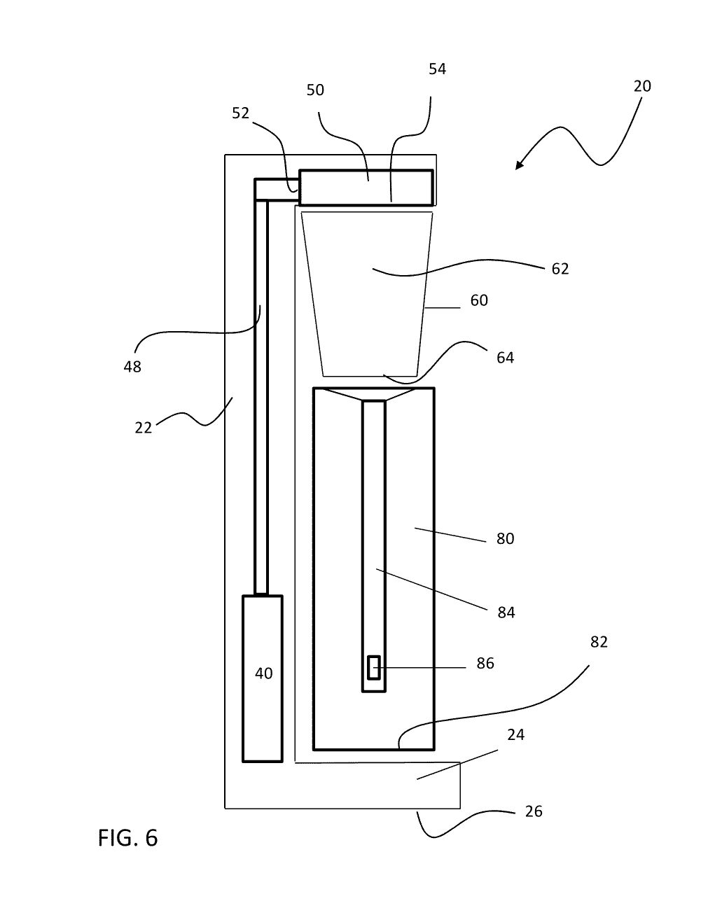

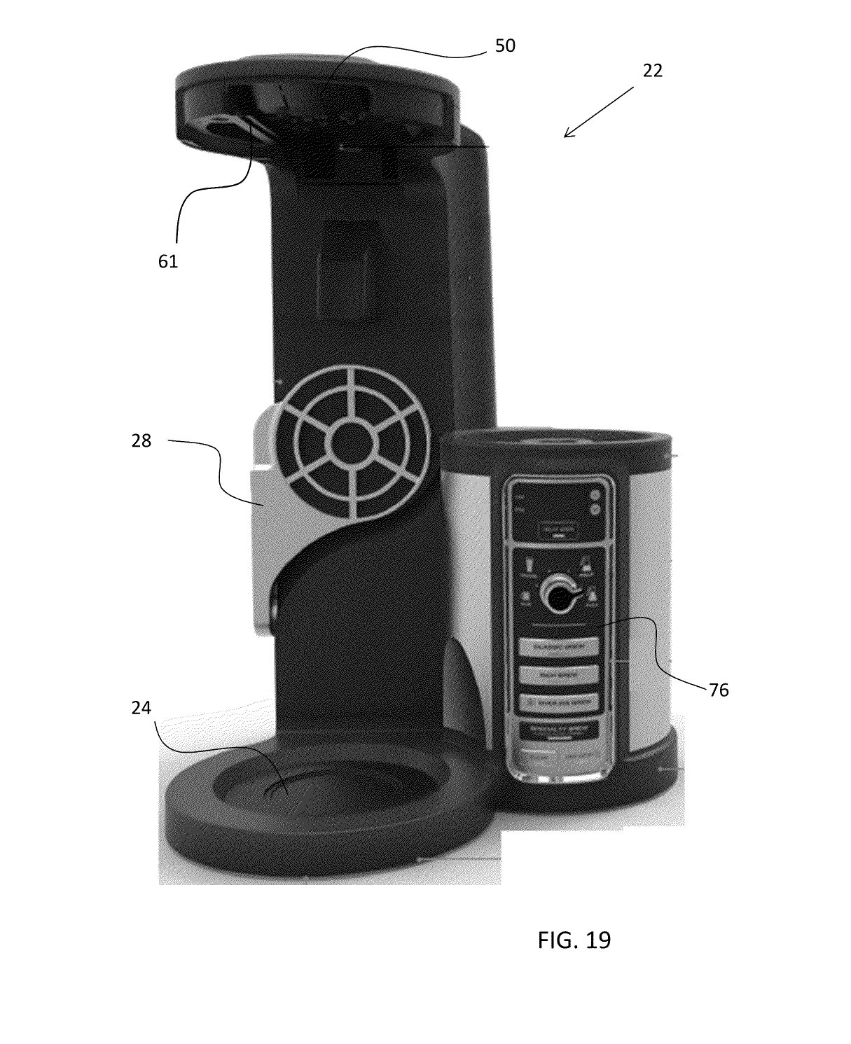

The brew basket 60 is removably coupled to the housing 22, such as via one or more rails 61 (see FIG. 19) for example, at a position vertically below the shower head 50. When viewed from the side, as shown in FIG. 6, the brew basket 60 extends further forward beyond the adjacent water reservoir 30. The brew basket 60 is generally hollow and includes a brew chamber 62 configured to receive ground coffee and to brew the ground coffee when hot water is introduced therein. In one embodiment, the brew chamber 62 is configured to receive a disposable or permanent coffee filter (not shown) in which the ground coffee may be disposed.

From the brew basket 60, the brewed coffee is directed into a vertically adjacent container 80 either directly or through one or more conduits or chambers. Examples of containers 80 configured for use with the beverage brewing apparatus 20, include, but are not limited to, a carafe, a half-carafe, a travel mug, and a mug for example. In one embodiment, the brewed beverage may drip from the outlet end 64 of the brew basket 60 into a straw 84 disposed within the container 80. The straw 84 may include an opening 86 located at any position, such as near a top of the container 80 or a bottom 82 of the container 80 for example. In a non-limiting embodiment, the straw 84 includes a single tooth configured to direct a flow direction of the brewed beverage in a single direction into the container 80.

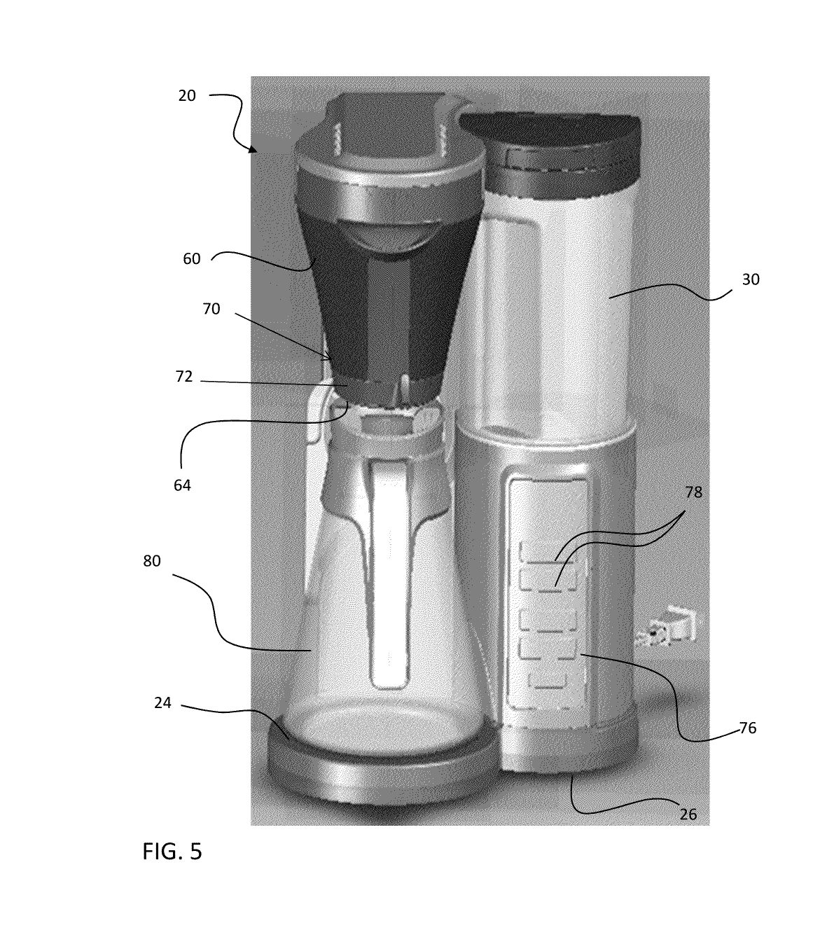

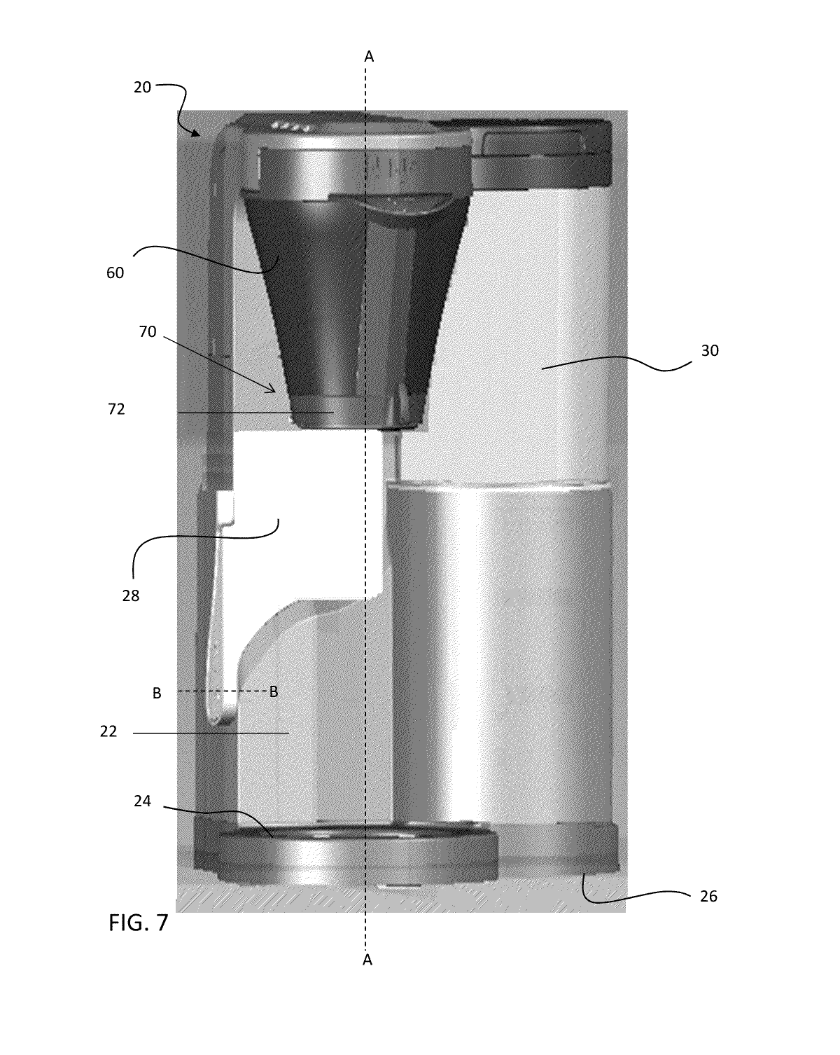

In one embodiment, the housing 22 includes a floor 24 configured to support a container 80 thereon. The floor 24 may be arranged generally adjacent a base 26 of the apparatus and may extend generally parallel to the shower head 50, such as beyond an adjacent portion of the housing including a user interface (best shown in FIG. 5). Alternatively, or in addition, a platform 28 movable between a stored position and a deployed position may be attached to a portion of the housing 22 such that when the platform 28 is in the deployed position, the platform 28 is configured to support a container 80 thereon. When the platform 28 is in the deployed position, the shower head 50, brew basket 60, platform 28, and floor 24 are substantially aligned about a vertical axis A (FIG. 7). In one embodiment, the platform 28 is generally parallel to the floor within about 5° when in the deployed position. As shown, the platform 28 is configured to pivot about an axis B extending generally perpendicular to the vertical axis A. However, other embodiments, such as where the platform is configured to pivot about an axis B, substantially parallel to axis A for example, are also within the scope of the disclosure. By positioning the platform 28 between the floor 24 and the brew basket 60, the platform 28 may be used to support smaller containers, such as a mug or travel mug for example, to limit the distance the brewed beverage drips from the outlet end 64 of the brew basket 60 into the container 80.

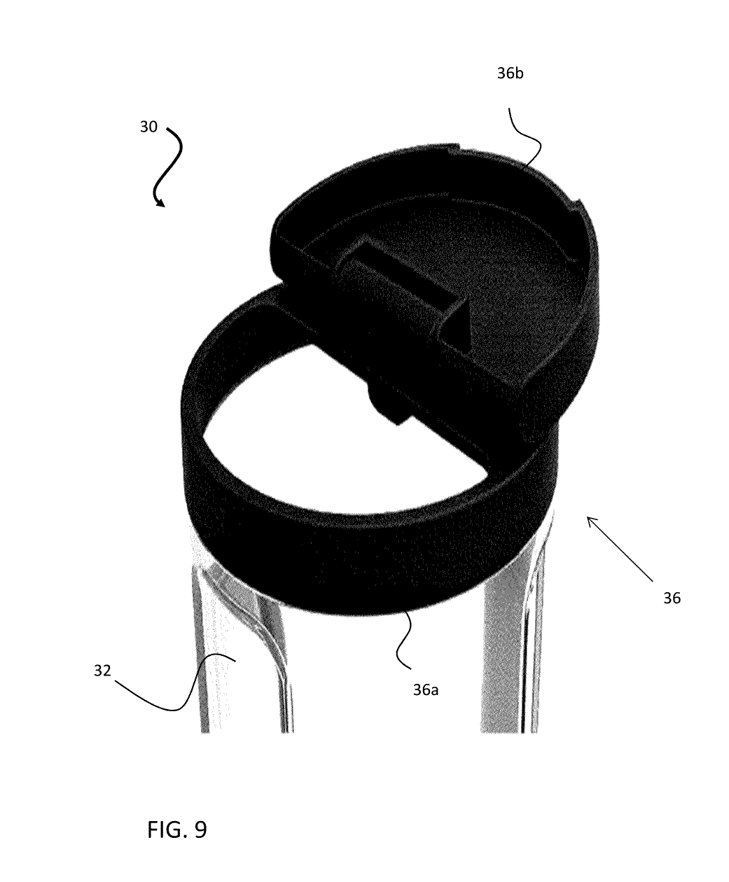

As best shown in FIG. 10, at least one overflow channel or orifice 66 may be formed in the brew basket 60, such as adjacent an edge 68 thereof. The overflow channel 66 is configured to drain excess water from the brew basket directly into the adjacent container. In one embodiment, the brew basket 60 includes a plurality of overflow channels 66 spaced about the periphery of the brew basket 60. In the event that an excess of water is supplied from the shower head 50 into the brew basket 60, a portion of the water will flow into the at least one overflow channel 66 to prevent the water from spilling over the edge 68 of the brew basket 60.

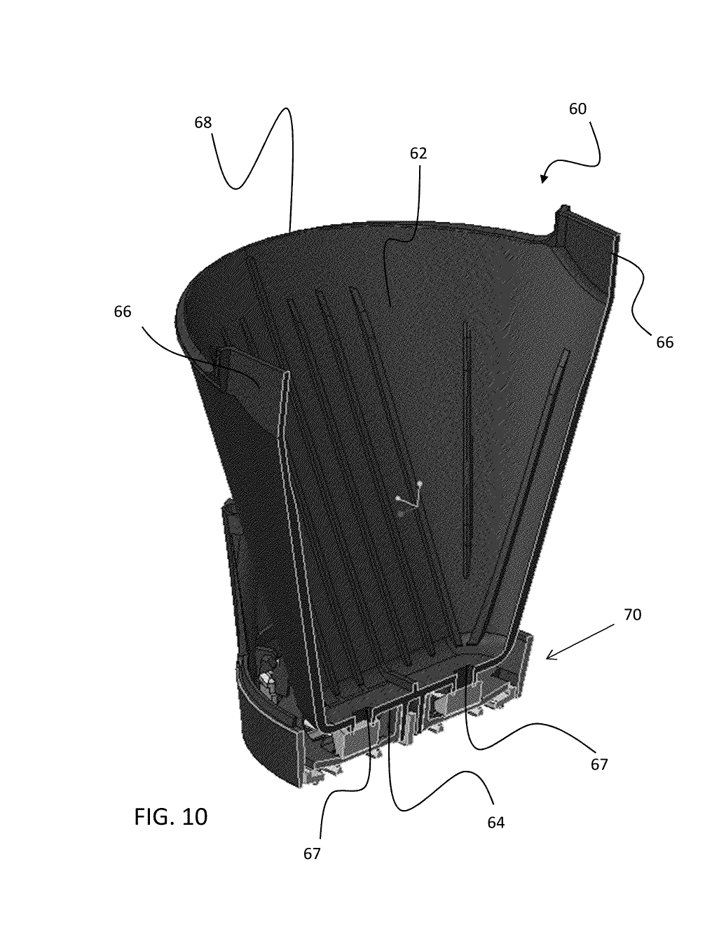

In one embodiment, the brew basket 60 is configured with a drip stop 70 including a movable collar 72 arranged at the outlet end 64 of the brew basket 60. The collar 72 has a specific geometric configuration including at least one gasket 73 and is rotatable between a first position and a second position. When the collar 72 is in the first position (FIG. 11a), the geometric configuration and the at least one gasket 73 are arranged to allow the brewed beverage to drip from at least one opening 74 formed in the outlet end 64 of the brew basket 60 into an adjacent container 80. When the collar 72 is in the second position (FIG. 11b), the geometric configuration and the at least one gasket 73 interfere with the at least one opening 74 of the brew basket 60 to block a flow of coffee therefrom. Inclusion of the drip stop 70 temporarily stops the flow of the brewed beverage from the brew basket 60, such as to allow the container 80 within which the brewed beverage is being collected to be changed. In one embodiment, the brew chamber 62 is capable of accumulating excess water without overflowing for at least 5 seconds when the drip stop assembly is closed.

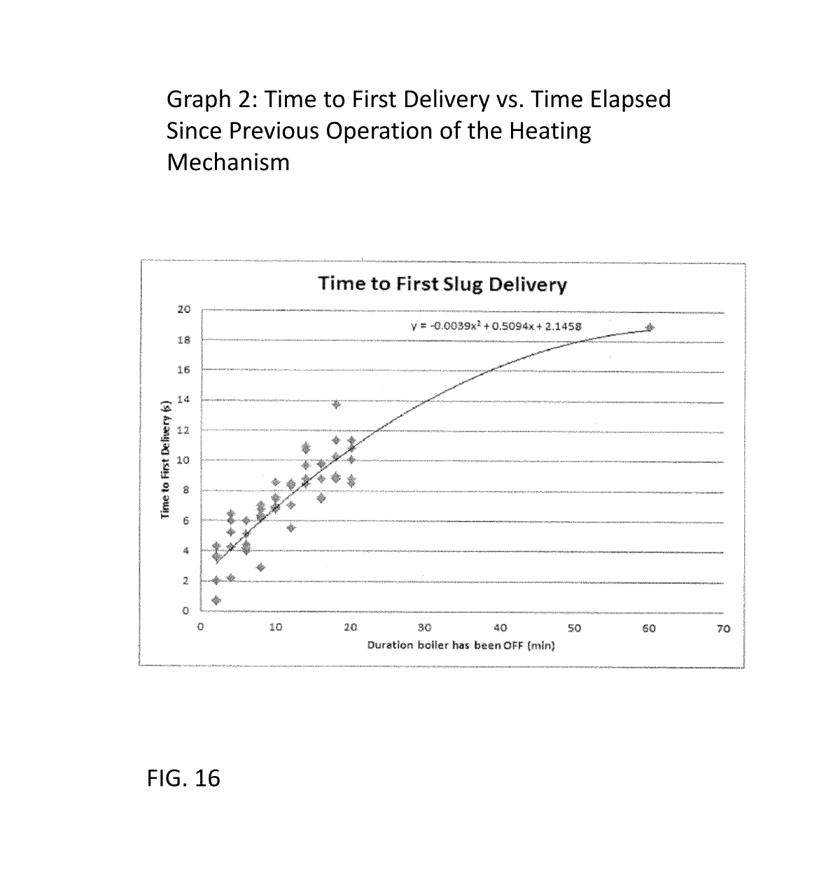

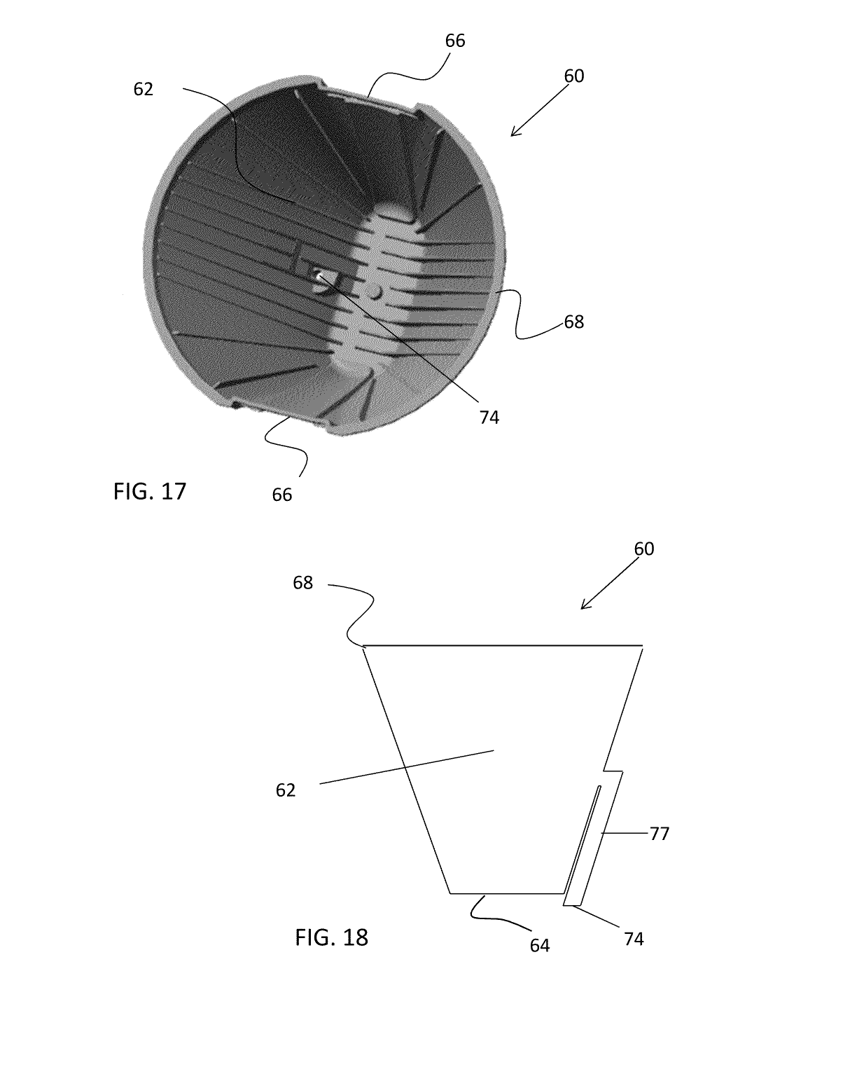

In the embodiments illustrated in FIGS. 10 and 11, the brew basket 60 includes a plurality of substantially identical openings 74 formed at the outlet end 64 thereof. In another embodiment, shown in FIGS. 17 and 18, the brew basket 60 includes a single opening 74 configured to provide a stream of fluid to the adjacent container 80. The single opening 74 may be formed adjacent the outlet end 64 of the brew basket 60, or alternatively, may include a siphon having a pipe 77 fluidly coupled to the brew chamber 62 and extending parallel to or at an angle to a sidewall 69 of the brew chamber 62 such that the exit point of the pipe 77 lies below the lowest surface holding fluids in the brew chamber 62. In such embodiments, filtrate is configured to flow out of the brew basket 60 in a siphoned manner if during the brewing process at least enough water has been poured into the brew chamber 62 to completely fill the bend in the pipe section 77. A brew basket 60 having a siphoned single stream provides the added benefits of reduced splashing due to a more laminar flow and a clean cut off with minimal dripping at the end of a brew operation. The drip stop 70 may be adapted for use with a brew basket 60 having one or more openings 74. For example, in embodiments where the brew basket 60 includes a single siphoned opening 74, the drip stop 70 may be configured to apply a pressure to or squeeze the pipe 77 to restrict a flow there through. In addition, a user interface 76 may be configured to indicate to an operator or user, such as via a light or other indicator for example, that the drip stop 70 is in a closed position.

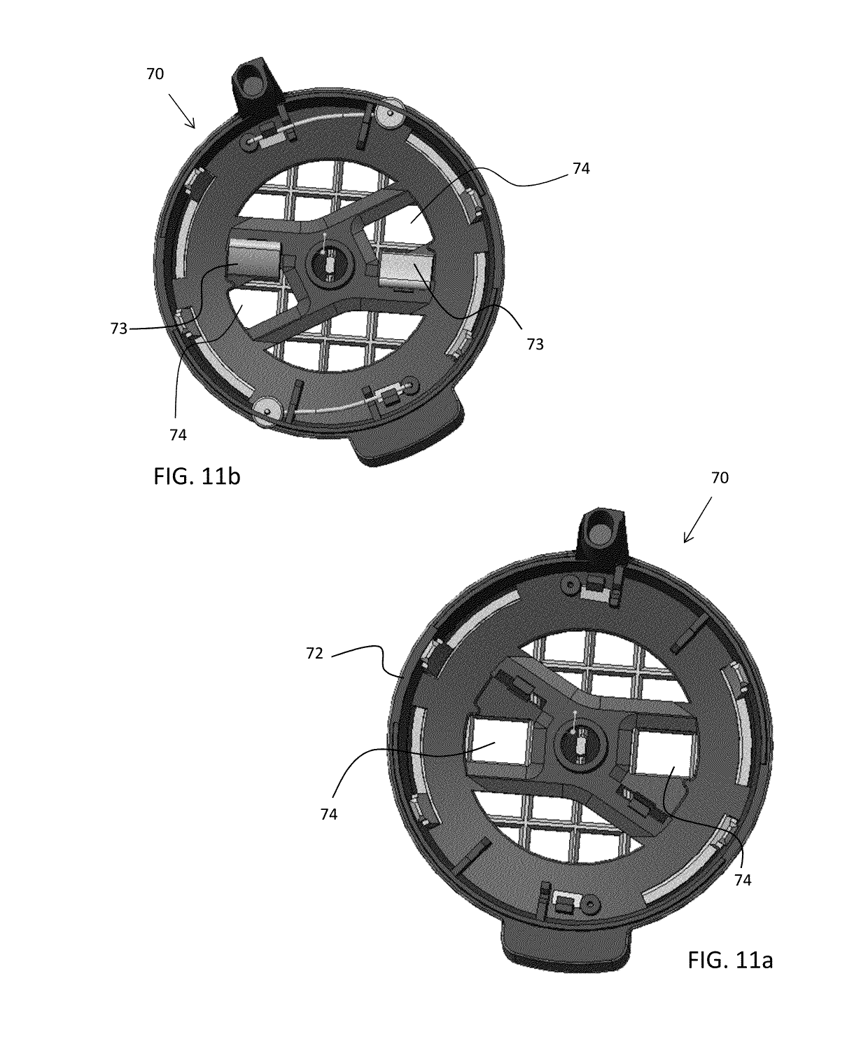

With reference now to FIGS. 12a and 12b, an example of the shower head 50 is illustrated in more detail. The shower head 50 is configured to evenly distribute the heated water over the ground coffee arranged within the brew chamber 62 of the brew basket 60. The shower head 50 includes a substantially hollow container having an inlet 52 fluidly connected to the heating mechanism 44 by the second conduit 48. In one embodiment, the base 54 of the shower head 50 is disposed above or within an orifice defined in a lid of the brew basket 60. As is visible in the FIGS., a vertical position of the shower head 50 is not to be lower than the lid 36 of the water reservoir 30.

At least one distribution hole 56 is formed in a base 54 of the shower head 50 to allow the heated water to flow there through and onto the ground coffee. As shown, the shower head 50 may include a plurality of distribution holes 56, each distribution hole 56 being configured to distribute water to a desired portion of the exposed surface area of the ground coffee. The plurality of distribution holes 56 may, but need not be substantially identical in size and shape. In the illustrated, non-limiting embodiment, the plurality of distribution holes 56 is arranged about the base 54 to evenly cover a surface of the ground coffee with minimal overlap of coverage provided by adjacent distribution holes 56. In one embodiment, the shower head 50 may include eight distribution holes 56 having a diameter of 2.5 mm equally spaced at a radius of 25 mm, three distribution holes 56 having a diameter of 2.5 mm equally spaced at a radius of 8.5 mm, and a central hole having a diameter of 7 mm. In addition, the outermost ring of holes may be offset from the centerline, such as 22.5° for example. The distribution holes 56 may also include a tapered boss (not shown) configured to encourage water to flow through the distribution holes 56 in droplet formation.

The plurality of distribution holes 56 may also be positioned about the base 54 to minimize or prevent the water from directly contacting the sides of the brew basket 60 or a filter arranged within the brew basket 60. In addition, the shower head 50 may be configured to fill at least partially with water before supplying the water to the brew chamber 60 via the one or more distribution holes 56. As a result, the water within the shower head 50 is supplied to each of the distribution holes 56, and therefore the ground coffee, evenly.

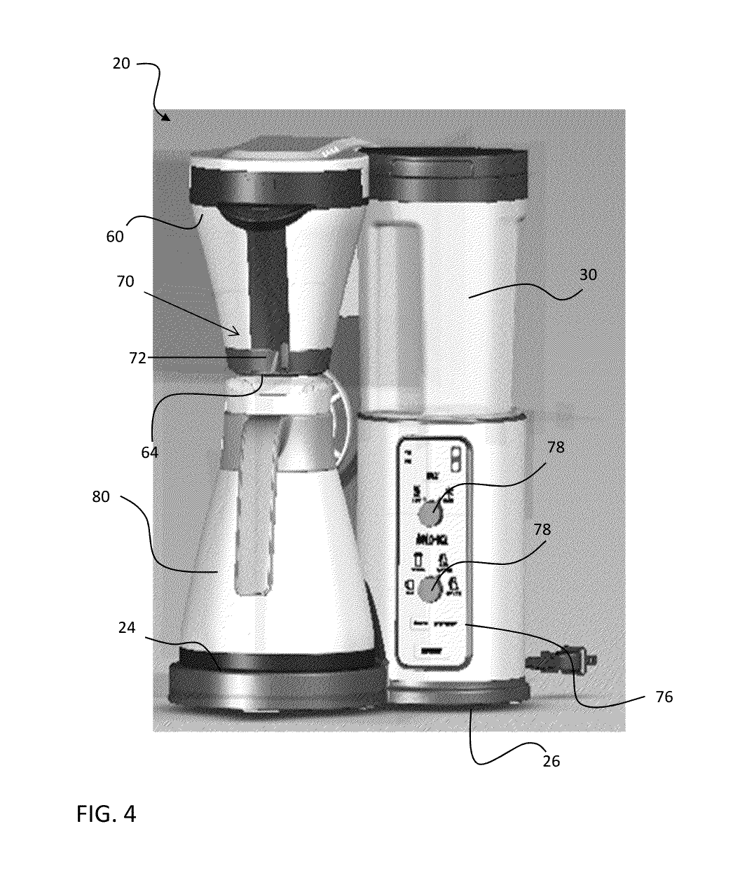

The apparatus 20 also includes a user interface 76, such as a panel arranged at an exterior of the housing for example. Examples of various configurations of the user interface 76 are illustrated in FIGS. 4, 5, and 19. The user interface 76 may include one or more buttons, knobs, or other control input devices 78, such as for selecting one of a plurality of sizes of the brewed beverage. Alternatively, the user interface 76 may include a touch screen. In one embodiment, the brew size may be selected from a mug (between about 6 and about 10 ounces), a travel mug (between about 12 and about 16 ounces), a half-carafe (between approximately 16 and 24 ounces), and a carafe (between about 34 and about 44 ounces). The user interface 76 additionally includes an input device 78 for selecting the type of beverage to be brewed, such as regular coffee, rich coffee, over-ice coffee, or specialty coffee for example.

In the illustrated, non-limiting embodiment, the beverage brewing apparatus 20 does not include a pump configured to supply water from the water reservoir 30 to the shower head 50. Rather, pressure generated by operation of the heating mechanism 44 is used to supply a desired volume of water to the shower head 50. When the heating mechanism 44 is inactive, the level of water within the water reservoir 30 and the level of water within the second conduit 48 are generally even, or arranged within the same horizontal plane, due to pressure equalization. When the heating mechanism 44 is active, the water disposed within the heating mechanism 44 is converted to hot water and steam. As a result of this expansion, the pressure within the second conduit 48 increases and forces the expulsion of a bubbling slug of water from the heating mechanism 48, through the second conduit 48, and into the shower head 50. After delivery of the slug, additional water flows from the water reservoir 30 into the heating mechanism 44 and second conduit 48 until the pressure acting on the water is again equalized.

Operation of the beverage brewing apparatus 20 is controlled by a controller 90 operably coupled to the heating mechanism 44 and the one or more input devices 78 of the user interface 76. The controller 90 is configured to operate the heating mechanism 44 to brew a beverage in response to the input signals received from the input devices 78 indicating at least a known size and type of brewed beverage. The controller 90 may include one or more or a microprocessor, microcontroller, application specific integrated circuit (ASIC), or any other form of electronic controller known in the art.

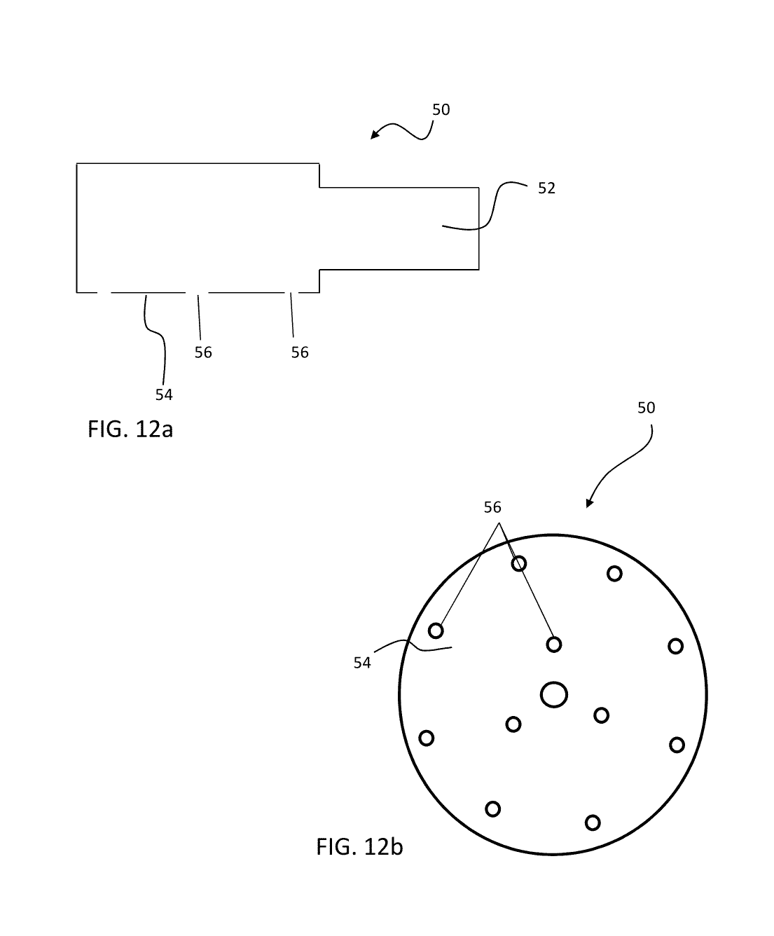

As indicated in Tables 1a-1d, parameters for brewing one or more sizes of various beverages are accessible by the controller. Based on a suggested amount of ground coffee used for each size, the parameters include an amount of bloom water, a bloom time, and an amount of brew water selected to achieve a desired flavor profile for each type of beverage. In the illustrated, non-limiting embodiment, the beverage brewing apparatus is configured to prepare any of a regular coffee, a rich coffee, an over-ice coffee and a specialty coffee. With reference to FIG. 13, the parameters used to prepare a regular coffee are intended to achieve a flavor profile having a % TDS between 1.15 and 1.35 and an extraction between about 18% and 22%. Similarly, the parameters used to prepare a rich coffee are intended to achieve a flavor profile having a % TDS between 1.35 and 1.55 and an extraction between about 18% and 22%. The flavor profiles of both the regular and rich coffees brewed by the apparatus 20 are indicated on FIG. 13, as region A and B, respectively. However, the ratio of water to ground coffee used to prepare the rich coffee may be less than used in the preparation of a regular coffee.

The parameters used to prepare an over-ice coffee are intended to achieve a brewed coffee flavor profile having a % TDS between 2.30 and 2.80 and an extraction between about 16% and 20%. The flavor profile of the over-ice coffee is indicated on FIG. 13 as region C. In one embodiment, the brewed ultra-rich coffee is configured to be received in a container filled at least partially with ice to form an iced coffee beverage. As is apparent, the flavor profile of the over-ice coffee is shifted diagonally relative to the profile for regular coffee to account for the dilution that occurs when over-ice coffee is provided to the container and dissolves at least a portion of the ice therein.

The parameters used to prepare a specialty coffee are intended to achieve a brewed coffee flavor profile having a % TDS between 2.80 and 3.80 and an extraction between about 15.5% and 20%. The flavor profile of the specialty coffee is indicated on FIG. 13 as region D. In one embodiment, the brewed specialty coffee is configured for use as flavoring in another food or beverage item. As is apparent, the flavor profile of the specialty coffee is shifted diagonally relative to the profile for regular coffee to account for the dilution that occurs when ultra-rich coffee is provided to the container and dissolves at least a portion of the ice therein.

TABLE 1a
Example of Regular Coffee Parameters
REGULAR COFFEE

| | Ground | Bloom | | Total | Target |
|---|---|---|---|---|---|
| | Coffee | Water | Bloom | Water | End |
| | Mass | Volume | Duration | Volume | Volume |
| Size | (g) | (mL) | (sec) | (mL) | (g) |
| Cup | 17 | 50 | 30 | 339 | 281 |
| Travel | 25.9 | 70 | 25 | 493 | 414 |
| Mug | | | | | |
| ½ | 34 | 120 | 15 | 658 | 562 |
| Carafe | | | | | |
| Carafe | 68 | 200 | 15 | 1281 | 1123 |

TABLE 1b
Example of Rich Coffee Parameters
RICH COFFEE

| | Ground | Bloom | | Total | Target |
|---|---|---|---|---|---|
| | Coffee | Water | Bloom | Water | End |
| | Mass | Volume | Duration | Volume | Volume |
| Size | (g) | (mL) | (sec) | (mL) | (g) |
| Cup | 17 | 50 | 45 | 314 | 258 |
| Travel | 25.9 | 70 | 40 | 465 | 390 |
| Mug | | | | | |
| ½ | 34 | 120 | 30 | 618 | 527 |
| Carafe | | | | | |
| Carafe | 68 | 200 | 15 | 1225 | 1054 |

TABLE 1c
Example of Over-Ice Parameters
OVER-ICE COFFEE

| | Ground | Bloom | | Total | Target |
|---|---|---|---|---|---|
| | Coffee | Water | Bloom | Water | End |
| | Mass | Volume | Duration | Volume | Volume |
| Size | (g) | (mL) | (sec) | (mL) | (g) |
| Cup | 17 | 50 | 45 | 163 | 111 |
| Travel | 25.9 | 70 | 60 | 244 | 174 |
| Mug | | | | | |
| ½ | 34 | 120 | 30 | 311 | 225 |
| Carafe | | | | | |
| Carafe | 68 | 200 | 15 | 609 | 468 |

TABLE 1d
Example of Specialty Parameters
SPECIALTY COFFEE

| | Ground | Bloom | | Total | Target |
|---|---|---|---|---|---|
| | Coffee | Water | Bloom | Water | End |
| | Mass | Volume | Duration | Volume | Volume |
| Size | (g) | (mL) | (sec) | (mL) | (g) |
| Cup | 17 | 50 | 30 | 133 | 93 |
| Travel | 25.9 | 70 | 60 | 176 | 123 |
| Mug | | | | | |
| ½ | 34 | 120 | 60 | 233 | 149 |
| Carafe | | | | | |
| Carafe | 68 | 200 | 60 | 453 | 298 |

In one embodiment, the recommended mass of ground coffee and volume of bloom water used generally remains constant for each brew size, regardless of which type of beverage is being prepared. For example, to prepare a cup or mug brew size of any of regular coffee, rich coffee, over-ice coffee, or specialty coffee, between about 14-20 g of ground coffee and between about 40-60 mL of bloom water is recommended to achieve a beverage having a flavor profile within region A, B, C, or D, respectively. Use of about 20-30 g of ground coffee and 60-80 mL of bloom water are suggested to prepare travel mug brew size of any of regular coffee, rich coffee, over-ice coffee, or specialty coffee. Similarly, to achieve a half carafe brew size of regular coffee, rich coffee, over-ice coffee, or specialty coffee having a desired flavor profile, between about 27-41 g of ground coffee and about 100-140 mL of bloom water are recommended. Preparation of a carafe brew size of regular coffee, rich coffee, over-ice coffee, or specialty coffee includes between about 54-82 g of ground coffee and between about 170-230 mL of bloom water.

The bloom time of a regular coffee of any size may be between about 12-36 seconds, the bloom time of a rich coffee of any size may be between about 12-54 seconds, the bloom time of an over-ice coffee of any size may be between 15-72 seconds, and the bloom time of a specialty coffee of any size may be between about 24-72 seconds. However, the bloom time, volume of brew water, and target end volume generally varies, not only based on the brew size selected, but also the beverage being prepared. A mug size portion of regular coffee has a recommended bloom time between about 24-36 seconds, a brew water volume between about 270-400 mL, and a target end volume between about 225-337 mL to achieve a flavor profile within region A. A mug size portion of rich coffee has a recommended bloom time between about 36-54 seconds, a brew water volume between about 235-345 mL, and a target end volume between about 189-283 mL to achieve a flavor profile within region B. A mug size portion of over-ice coffee has a recommended bloom time between 36-54 seconds, a brew water volume between 130-196 mL, and a target end volume between about 89-133 mL to achieve a flavor profile within region C. Similarly, a mug size portion of specialty coffee has a recommended bloom time between 24-36 seconds, a brew water volume between 110-150 mL, and a target end volume between about 80-100 mL to achieve a flavor profile to achieve a flavor profile within region D.

Similarly, preparation of a travel mug portion of regular coffee has a recommended bloom time between about 20-30 seconds, a brew water volume between about 395-591 mL, and a target end volume between about 331-497 mL to achieve a flavor profile within region A. A travel mug portion of rich coffee has a recommended bloom time between about 32-48 seconds, a brew water volume between about 351-527 mL, and a target end volume between about 293-439 mL to achieve a flavor profile within region B. A travel mug portion of over-ice coffee has a recommended bloom time between 48-72 seconds, a brew water volume between 195-293 mL, and a target end volume between about 139-209 mL to achieve a flavor profile within region C. Similarly, a travel mug size portion of specialty coffee has a recommended bloom time between 48-72 seconds, a brew water volume between 150-200 mL, and a target end volume between about 100-140 mL to achieve a flavor profile to achieve a flavor profile within region D.

Preparation of a half carafe of regular coffee has a recommended bloom time between about 12-18 seconds, a brew water volume between about 526-790 mL, and a target end volume between about 465-674 mL to achieve a flavor profile within region A. A half carafe of rich coffee has a recommended bloom time between about 24-36 seconds, a brew water volume between about 458-698 mL, and a target end volume between about 393-589 mL to achieve a flavor profile within region B. A half carafe of over-ice coffee has a recommended bloom time between 24-36 seconds, a brew water volume between 249-373 mL, and a target end volume between about 180-270 mL to achieve a flavor profile within region C. Similarly, a half carafe size portion of specialty coffee has a recommended bloom time between 48-72 seconds, a brew water volume between 210-250 mL, and a target end volume between about 130-170 mL to achieve a flavor profile to achieve a flavor profile within region D.

Lastly, preparation of a carafe of regular coffee includes a recommended bloom time between about 12-18 sec, a brew water volume between about 1025-1537 mL, and a target end volume between about 898-1348 mL to achieve a flavor profile within region A. Recommendations for preparing a rich coffee include a bloom time between about 12-18 seconds, a brew water volume between about 919-1379 mL, and a target end volume between about 788-984 mL to achieve a flavor profile within region B. A carafe of over-ice coffee has a recommended bloom time between 12-18 seconds, a brew water volume between 496-745 mL, and a target end volume between about 374-562 mL to achieve a flavor profile within region C. Similarly, a carafe size portion of specialty coffee has a recommended bloom time between 48-72 seconds, a brew water volume between 430-470 mL, and a target end volume between about 280-320 mL to achieve a flavor profile to achieve a flavor profile within region D.

Various methods exist for controlling the amount of water supplied to the ground coffee as either bloom water or brew water. As illustrated in FIG. 2, a flow meter 92 may be arranged within the first conduit 46 extending between the water reservoir 30 and the heating mechanism 44. As shown, the water reservoir 30 may be vertically aligned with the flow meter 92 such that water is fed to the system 20, and more specifically to the flow meter 92, by gravity. The flow meter 92 is operably coupled to the controller 90 and is configured to monitor an amount of water passing there through. Due to the equalized pressure within the fluid system, the amount of water that passes through the flow meter 92 is generally indicative of the amount of water provided to the shower head 50. Various types of flow sensors are within the scope of the disclosure. In embodiments where the flow meter 92 is a paddle wheel, each rotation of the wheel sends a signal to the controller 90 indicating that a known amount of water has passed through the flow meter 92. Once a predetermined volume of water has passed through the flow meter 92, the controller 90 turns off the heating mechanism 44 to limit further flow of the water to the shower head 50. In another embodiment, the flow meter 92 is an ultra-sonic flow meter configured to measure a velocity of the water via ultrasound to calculate a volume flow. Alternatively, the flow meter 92 may be a capacitive flow sensor configured to measure a displacement thereof caused by dynamic water pressure to measure the velocity of the flow of the water.

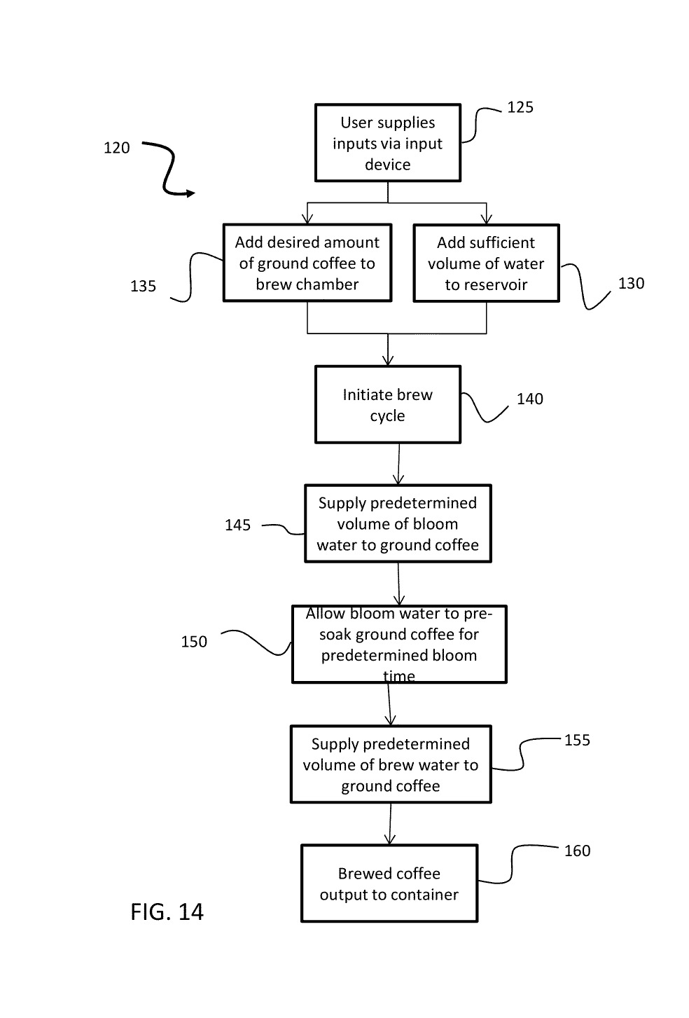

In another embodiment, the amount of water supplied to the shower head 50 is monitored by an algorithm stored within the controller 90. The algorithm is a function of the delivery rate of a cool temperature water to the shower head and the amount of time since the heating mechanism 44 was last used. As illustrated in Graph 1 of FIG. 15, the graph representing the volume of water delivered vs. time includes an initial “warm-up” period where power is applied to the heating mechanism 44, but no water is delivered to the shower head 50. Only once the delivery of the water to the shower head 50 is initiated does the graph become linear. The slope of the line varies based on the temperature of the water within the reservoir 30. The volume delivered at any given time period can be represented by the equation:

Vol=rate*(time−warm up time).

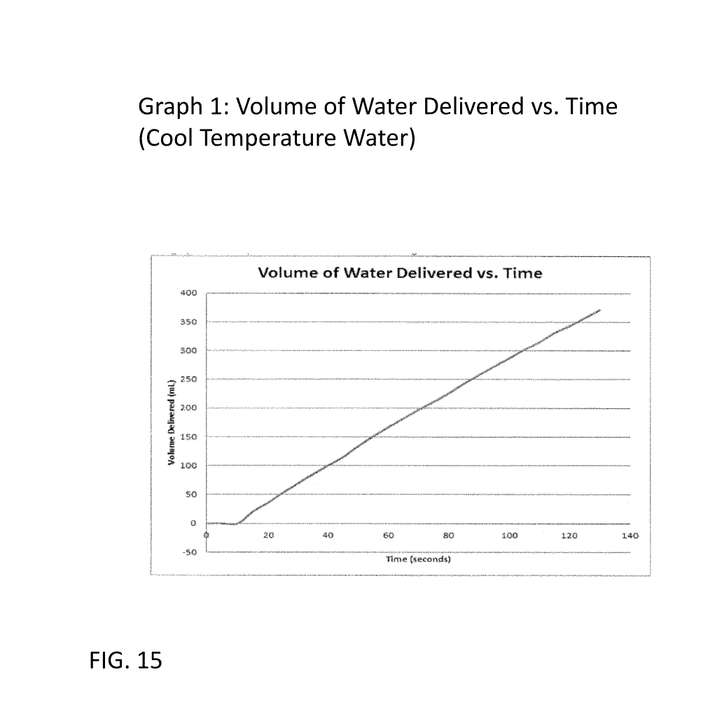

The warm up period is directly influenced by the time since the heating mechanism 44 was last energized. Graph 2 of FIG. 16 illustrates the warm-up period of the heating mechanism 44 as a function of the time elapsed since operation of the heating mechanism 44.

As shown, as the temperature of the heating mechanism 44 reaches ambient conditions, the time required to warm-up the heating mechanism 44 will asymptotically approach its limit. In the illustrated, non-limiting embodiment, Graph 2 is based on the assumption that the temperature of the heating mechanism 44 will equal the ambient temperature for any elapsed time greater than or equal to one hour. The time required to warm-up the heating mechanism 44 may also vary based on the temperature of the water. In one embodiment, the apparatus 20 may include a thermistor or other sensor configured to monitor the temperature of the water. In such instances, the algorithm may be adapted to account for water temperature to more accurately determine a length of time for which the heating mechanism 44 should be energized to supply a desired amount of water to the shower head 50.

Alternatively, a temperature sensor (not shown), such as a negative temperature coefficient thermistor for example, may be configured to monitor a temperature of the heating element. The temperature sensor is operably coupled to the controller such that the controller continuously monitors a temperature of the heating mechanism. The controller compares a value recorded by the temperature sensor with a stored reference value to determine a state of the heating mechanism. When the value recorded by the temperature sensor reaches a predetermined threshold, it can be determined that the warm-up of the heating mechanism 44 is complete.

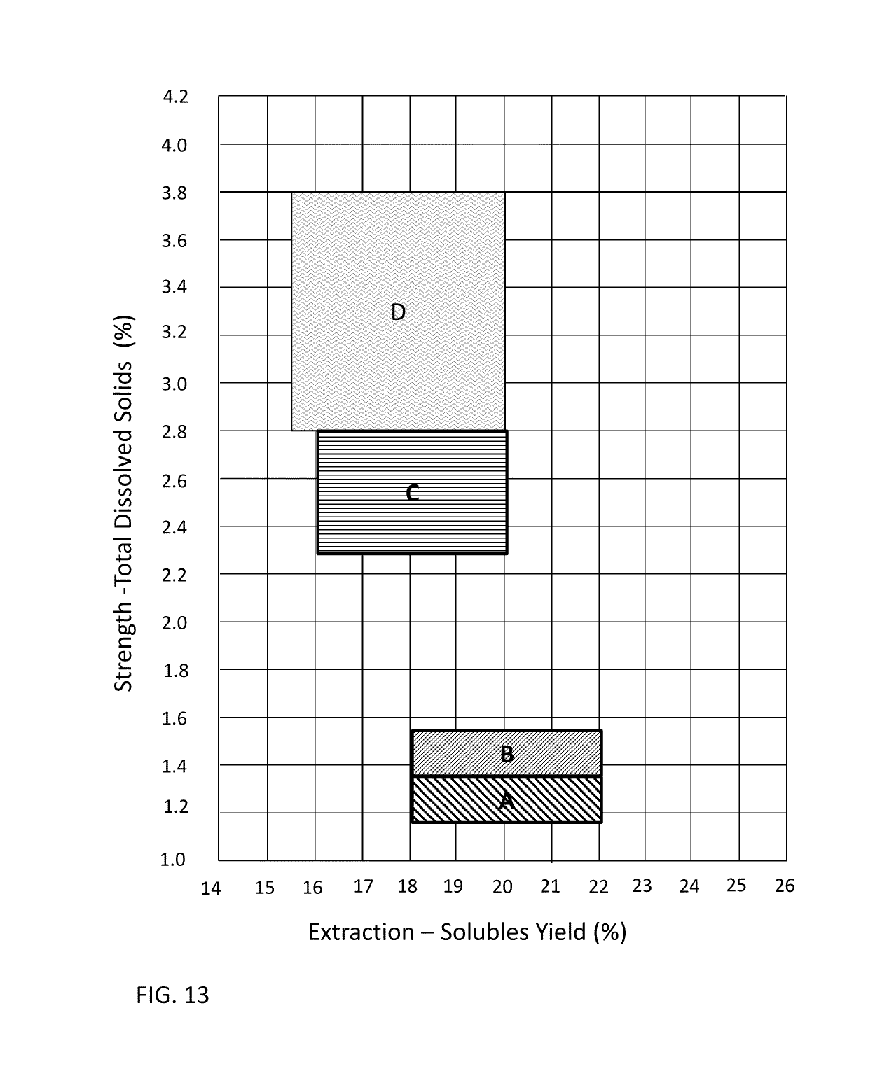

A method 120 of brewing a beverage using the beverage brewing apparatus 20 is illustrated in the flowchart of FIG. 14. In operation, a user selects a brew size and a type of beverage to be brewed by the apparatus, for example using the one or more input devices 78, as shown in block 125. In block 130, the user adds a sufficient amount of water to the water reservoir 30 to brew a beverage of the selected size. Similarly, in block 135, the user additionally adds ground coffee to the brew chamber 62 of the brew basket 60 in an amount appropriate for the selected brew size. In one embodiment, the brew basket 60, or the filter arranged therein, may include one or more markings 65 (see FIG. 10), such as formed on an exterior surface thereof or within the brew chamber 62 for example, indicating a suggested amount of ground coffee appropriate for one or more of the selectable brew sizes. In other embodiments, the apparatus 20 may be configured to automatically add water to the water reservoir 30 and/or ground coffee to the brew basket 60 from sources of water and ground coffee, respectively.

In one embodiment, a sensor 94 (see FIG. 2) is operably coupled to the controller 90 and configured to detect the presence of water in the reservoir 30. An example of the sensor 94 may include two conductive pins mounted near the outlet end 38 of the reservoir 30 adjacent the input tube 46. A circuit between the pins is shorted when water is present within the reservoir 30. If the sensor 94 generates a signal indicating that there is no water within the reservoir 30, the controller 90 will either cease operation of the heating mechanism 44 or will not energize the heating mechanism 44. In addition, the user interface 76 may be configured to indicate to an operator or user, such as via a light or other indicator for example, that not water is present within the reservoir 30.

In block 140, after an appropriate amount of water and ground coffee has been added to the apparatus 20, the user may initiate the brewing process, such as via an input device 78 for example. Alternatively, the apparatus 20 may be configured to automatically begin brewing a beverage in response to a signal from a timer or other programming device. Water within the heating mechanism 44 is heated to a desired temperature. The heated water and steam generated builds up a pressure within the heating mechanism 44 such that a first portion of the water, used as the bloom water, is supplied through the second conduit 48 to the shower head 50 where it is distributed onto the ground coffee in the brew chamber 62, as shown in block 145. The volume of bloom water supplied to the ground coffee is a predetermined amount that varies based on the selected brew size and the type of beverage being brewed. The amount of bloom water supplied to the ground coffee is sufficient to moisten a portion or all of the ground coffee in the brew chamber 62, but insufficient to cause a significant amount of, or any, water to exit into the container 80.

The bloom water pre-soaks the ground coffee for a predetermined period of time, as shown in block 150. The bloom time is also variable based on the selected brew size and the type of beverage being brewed. After allowing the bloom water to pre-soak the ground coffee for the bloom time, as shown in block 155, the controller 90 again energizes the heating mechanism 44 to heat and direct a volume of brew water to the brew chamber 62. In block 160, the heated brew water enters the brew chamber 62 to produce coffee which is directed through the ground coffee and into the container 80, thereby completing the brew cycle.

A heater plate 96, shown in FIG. 2, may be positioned within the housing 22, such as directly adjacent the floor 24 for example. The heater plate 96 is operably coupled to the controller 90 and may be configured to selectively heat a brewed beverage stored within a container 80 located on the floor 24. To prevent the heat supplied by the heater plate 96 from negatively affecting the flavor of the brewed beverage, such as by breaking down the fats or compounds within the coffee for example, a thermal regulation device 98 may be configured to monitor the temperature of the container 80 and/or the brewed beverage. In one embodiment, the thermal regulation device 98 is a thermostat configured to automatically block power to the heater plate 96 when the container 80 exceeds a predetermined temperature. In another embodiment, the thermal regulation device 98 is a thermistor coupled to the controller 90. In such embodiments, if the resistance of the thermistor is outside of an allowable range, thereby indicating that the temperature of the container 80 is greater than a desired temperature, the controller 90 will remove power from the heater plate 96.

By allowing the controller 90 to vary the parameters for a brewed beverage based on the volume and the type of beverage being brewed, the apparatus 20 is configured to prepare a plurality of brewed beverages, each having an optimized flavor profile. As a result of this customization, more pleasant tasting beverages may be achieved.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A beverage system, comprising:
a housing including a water outlet;
a water reservoir mounted to said housing, said water reservoir being arranged in fluid communication with said water outlet via at least one fluid conduit;
a flow meter disposed within said at least one fluid conduit, said flow meter being configured to measure a volume of water supplied to said water outlet; and
a heating mechanism configured to heat at least a portion of the water within said at least one fluid conduit, wherein water is selectively supplied to said water outlet without a pump.

2. The beverage system according to claim 1, wherein water is selectively supplied to said water outlet by operating said heating mechanism.

3. The beverage system according to claim 2, wherein pressure generated by operating said heating mechanism is configured to supply a volume of water to said water outlet.

4. The beverage system according to claim 2, wherein said heating mechanism and said flow meter are operably coupled to a controller.

5. The beverage system according to claim 4, wherein said controller is configured to control operation of said heating mechanism based on said volume of water measured by said flow meter.

6. The beverage system according to claim 1, wherein water from said water reservoir is fed to said flow meter by gravity.

7. The beverage system according to claim 1, wherein said flow meter is a paddle wheel.

8. The beverage system according to claim 1, wherein said heating mechanism is operable only when the water reservoir contains a fluid.

9. A beverage system, comprising:
a housing configured to receive a container for storing a beverage prepared by the beverage system;
a heating mechanism positioned within said housing, said heating mechanism being configured to selectively heat said beverage within said container; and
a thermal regulation device operably coupled to said heating mechanism, said thermal regulation device being configured to monitor a temperature of at least one of said beverage and said container such that said temperature remains within a predetermined threshold to maintain a flavor profile of the beverage.

10. The beverage system according to claim 9, wherein if said temperature exceeds a predetermined threshold, power is removed from said heating mechanism.

11. The beverage system according to claim 9, wherein said heat provided by said heating mechanism affects said flavor profile of said beverage when said heat breaks down one or more compounds within said beverage.

12. The beverage system according to claim 9, wherein said thermal regulation device is a thermistor.

13. The beverage system according to claim 9, wherein said thermal regulation device is a thermostat.

14. The beverage system according to claim 9, wherein said housing includes a floor configured to receive said container and said heating mechanism is positioned within said floor.

15. A beverage system, comprising:
a housing configured to receive a container;
a shower head mounted to the housing, the shower head being substantially vertically aligned with said container;
a water reservoir removably coupled to a portion of the housing; and
a brew basket removably mounted to said housing directly beneath said shower head, the brew basket including:
a generally hollow body configured to define a brew chamber therein; and
at least one outlet opening formed in said body and fluidly coupled to said brew chamber.

16. The beverage system according to claim 15, wherein said generally hollow body includes at least one overflow orifice configured to stow a volume of fluid to prevent overflow.

17. The beverage system according to claim 16, wherein said at least one overflow orifice is positioned adjacent a sidewall of said hollow body.

18. The beverage system according to claim 15, wherein said at least one outlet opening includes two substantially identical outlet openings.

19. The beverage system according to claim 15, wherein said at least one outlet opening includes a single outlet opening.

20. The beverage system according to claim 19, wherein the single outlet opening includes a siphon having a pipe fluidly coupled to the brew chamber and extending from a sidewall of said hollow body.

21. The beverage system according to claim 15, further comprising a flow control device mounted to said hollow body adjacent said at least one opening, said flow control device being configured to selectively control a flow of the fluid through the at least one opening.

22. The beverage system according to claim 21, wherein said flow control device is movable between a first position where fluid is configured to flow freely through said at least one opening, and a second position where no fluid is configured to flow through said at least one opening.

23. The beverage system according to claim 15, wherein said hollow body is configured to slidably mount to one or more rails of said housing.

24. The beverage system according to claim 15, wherein said water reservoir and said portion of said housing to which said water reservoir is coupled are substantially identical in diameter.

25. The beverage system according to claim 15, wherein said brew basket and said shower head are laterally offset from said water reservoir.

26. The beverage system according to claim 15, further comprising a platform mounted to said housing, said platform being movable between a retracted position and an extended position, wherein in said extended position said floor, said platform, said brew basket, and said shower head are substantially aligned about a vertical axis.

27. A beverage system, comprising:
a housing including a flow meter;
a water reservoir configurable with said housing and including a chamber for receiving a liquid, said water reservoir being arranged in fluid communication with said flow meter, said water reservoir being disposed vertically above said flow meter such that a flow of said liquid from said chamber to said flow meter is driven by gravity.

28. The beverage system according to claim 27, wherein said liquid is configured to flow from said chamber until reaching equilibrium.

29. The beverage system according to claim 27, wherein said flow meter is arranged within a fluid conduit, upstream from a heating mechanism.

30. The beverage system according to claim 27, wherein said flow meter is a paddle wheel.
